(19) United States
(12) Patent Application Publication
(10) Pub. No.: US 2003/0225562 A1
(43) Pub. Date: Dec. 4, 2003

(54) Method and apparatus for characterizing timing-sensitive digital logic circuits

(75) Inventor: Manish Singh, Sunnyvale, CA (US)

Correspondence Address: David B. Ritchie, Thelen Reid & Priest LLP, P.O. Box 640640, San Jose, CA, 95164-0640, US

(73) Assignee: Sun Microsystems, Inc., a Delaware Corporation

(21) Appl. No.: 10/157,269

(22) Filed: May 28, 2002

(51) Int. Cl. G06F 17/50

(52) U.S. Cl. 703/19

(57) ABSTRACT

A method for characterizing a timing value of a timing-sensitive digital logic circuit includes (a) setting a set of input signal parameters such that the transition edge of an input signal is placed a selected time interval from an active edge of a clock signal, (b) conducting a circuit simulation, (c) observing an output signal and determining validity thereof, (d) shifting the transition edge by a window having a given time width, (e) simulating the circuit so as to determine the validity of the output signal, (f) iterating the shifting and the simulating by doubling the time width of the window for each iteration unless the doubled time width exceeds half the clock cycle and until the validity of the output signal changes, and (g) defining a solution window between the transition edge yielding the last valid output signal and the transition edge yielding the last invalid output signal.

### FIELD OF THE INVENTION

The present invention relates to the characterization of digital circuits. More particularly, the present invention relates to a method and apparatus for characterizing timing-sensitive digital logic circuits.

### BACKGROUND OF THE INVENTION

Designing integrated circuits (ICs) typically involves simulation and characterization of the digital circuits to be implemented on the IC. Such simulation/characterization is performed using various electronic design automation (EDA) tools before the IC design is physically implemented. Characterization of cells or circuit cores is typically implemented with an automatic characterization tool which generates a set of input parameters or test vectors for a circuit simulation tool (circuit simulator). Simulation tools typically utilize a transistor-level Simulation Program with Integrated Circuit Emphasis (SPICE), which was initially developed at the University of California at Berkeley, and its enhanced versions such as HSpice, SmartSpice, StarSpice, and the like, available from various simulation tool vendors such as Mentor Graphics Corporation of Wilsonville, Oreg., Cadence Design Systems of San Jose, Calif., Synopsys, Inc. of Mountain View, Calif. Such a characterization tool allows the user to characterize circuit behavior or attributes such as intrinsic delay, setup and hold times of registers, input capacitance, clock-to-Q delay, and the like.

Current sub-micron semiconductor process technologies enable IC designs to have more than 100 million transistors and to operate at clock frequencies in the range of more than 10¹² cycle per second. Rapid development of new products requires a shorter time-to-market of IC designs. However, as the complexity of the IC design dramatically increases, circuit simulation and characterization processes to predict and evaluate the chip performance promptly and accurately become more challenging.

### BRIEF DESCRIPTION OF THE INVENTION

A method characterizes a timing-sensitive digital logic circuit receiving an input signal and producing an output signal in accordance with a clock signal. The method includes defining a clock signal with a set of clock signal parameters, defining an input signal with a set of input signal parameters, and characterizing a timing value of the circuit. The clock signal parameters include a timing of an active edge and a clock cycle, and the input signal parameters include a timing of transition edges. The timing value of the circuit is a time period from the active edge of the clock signal to a transition edge of the input signal required to produce a valid output signal. Characterizing the timing value includes (a) setting a set of input signal parameters such that the transition edge is placed a selected time interval from the active edge of the clock signal, (b) conducting simulation of the circuit, (c) observing the output signal and determining validity of the output signal, (d) shifting, by changing the input signal parameters, the transition edge by a window having a given time width, (e) simulating the circuit so as to observe and determine the validity of the output signal, (f) iterating the shifting and the simulating by doubling the time width of the window for each iteration unless the doubled time width exceeds half the clock cycle and until the validity of the output signal changes, and (g) defining a solution window between the transition edge yielding the last valid output signal and the transition edge yielding the last invalid output signal. The characterizing may further includes determining the timing value with a predetermined resolution within the solution window by binary search. Once a first timing value is characterized, a second timing value is characterized using the first timing value and the width of the solution window defined for the first timing value.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is an electrical block diagram schematically illustrating a circuit model for characterizing a timing-sensitive digital logic circuit in accordance with one embodiment of the present invention.

FIG. 2 is a process flow diagram schematically illustrating a method for characterizing a timing-sensitive digital logic circuit in accordance with one embodiment of the present invention.

FIG. 3 is a diagram schematically illustrating the simulation waveforms of a clock signal and an input signal in accordance with one embodiment of the present invention.

FIG. 4 is a process flow diagram schematically illustrating a method for characterizing a timing-sensitive digital logic circuit in accordance with one embodiment of the present invention.

FIG. 5 is a diagram schematically illustrating the waveforms of an input signal (D), a clock signal (CLK), and an output signal (Q) in a linear search in accordance with one embodiment of the present invention

FIG. 6 is a diagram schematically illustrating the waveforms of an input signal (D), a clock signal (CLK), and an output signal (Q) in a binary search in accordance with one embodiment of the present invention.

FIG. 7 is a process flow diagram schematically illustrating a method for characterizing a timing-sensitive digital logic circuit in accordance with one embodiment of the present invention.

FIG. 8 is a diagram schematically illustrating the waveforms of an input signal (D), a clock signal (CLK), and an output signal (Q) in accordance with one embodiment of the present invention.

### DETAILED DESCRIPTION

Embodiments of the present invention are described herein in the context of a method and apparatus for characterizing a timing-sensitive digital logic circuit. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure. In accordance with the present invention, the components, process steps, and/or data structures may be implemented using various types of operating systems, computing platforms, computer programs, and/or general-purpose machines.

In accordance with one embodiment of the present invention, the characterization of a timing-sensitive digital logic circuit is implemented using an auto-characterization tool for a transistor-level circuit simulator, for example, a SPICE based simulation tool HSPICE, Star-Spice, both available from Avanti! Corporation of Fremont, Calif., or the like. Such an auto-characterization tool may include one or more modules for characterizing one or more specific attributes of a circuit. A circuit of interest is refereed to as a Device Under Test (DUT) in this specification. The characterization modules include, for example, an intrinsic delay module, an input capacitance module, a setup-hold time module, a clock-to-Q module, and the like.

Each characterization module typically has its own circuit model and characterization algorithm to accomplish its specific task. A control file may be used to set characterization/simulation commands for the auto-characterization tool. The commands include the setting of global parameters such as a simulation timestep (a time step used in a transient simulation), a simulation timestop (the total simulation time), simulation options, input signal/pulse waveform parameters, simulation conditions, and the like. The commands also include the setting of local parameters such as setting of a particular buffer for an input pin, setting of a capacitor load, setting of a trigger (measuring) point, setting of the delay from a particular input pin to a particular output pin, and the like. The local parameters may have their default values used when the user does not specify them. Such local parameters may be distinctive to each characterization module. Some parameters such as a clock signal waveform and an input signal/pulse waveform, as well as the report format of each module may be defined by the characterization tool without the user control. The simulation commands also include action commands to initiate the characterization of each module.

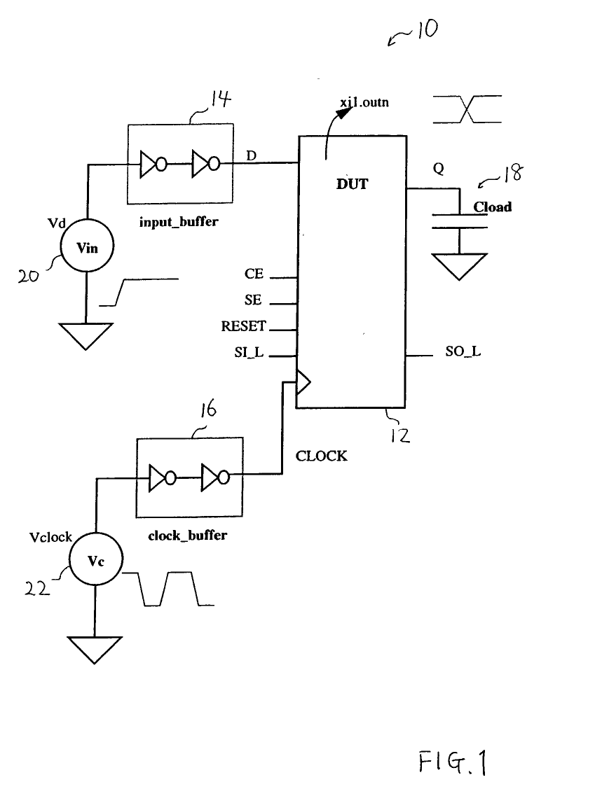

FIG. 1 schematically illustrates a circuit model 10 for characterizing a timing-sensitive digital logic circuit in accordance with one embodiment of the present invention. The circuit model 10 defines a simulation environment for characterization. The circuit model 10 includes a timing-sensitive digital logic circuit (DUT) 12, which is instantiated along with an input buffer 14, a clock buffer 16, and a load capacitor 18 at an output pin. The timing-sensitive digital logic circuit 12 may be a flip-flop, latch, or the like. As shown in FIG. 1, the digital logic circuit 12 receives an input signal (at an input pin D) and producing an output signal (at an output pin Q) in accordance with a clock signal (at a clock input pin CLOCK). Values of the both buffers 14 and 16 and the load capacitor 18 may be specified by the user.

In accordance with one embodiment of the present invention, the DUT is being presented as a netlist for a circuit simulator in the characterization environment. The characterization tool may follow the control file so as to provide the input buffers 14 and 16, voltage sources 20 and 22 to input pins, and the load 18 to the output pin. The characterization tool also creates appropriate “.measure” statements, and eventually generates a simulation deck for the circuit simulator. Then the circuit simulator is called to carry out the simulations. After every simulation, the characterization tool extracts the simulated information from the circuit simulator's output files and performs calculations. Finally, it sends out the results to the report file.

It should be noted that the input signal to be characterized is not limited to the input signal from the data input pin D, or a specific signal path (“arc”) form the input pin D to the output pin Q. Other input signals (or other input pins) such as clock enable (CE), scan enable (SE), and reset (RESET_L) signals can also be characterized. The arc form a scan input (SI_L) to a scan output (SO_L) may be characterized as well. The input buffers 14 and 16 can be re-defined using appropriate commands such as input_buffer and clock_buffer during the simulation/characterization process. The “xil.outn” shown in FIG. 1 represents an internal node at which the voltage level is observed against the characterization criteria for each timing value (described below).

The circuit model 10 is used for characterizing at least one timing value of the timing-sensitive digital logic circuit 12. The timing value is a time period from an active or triggering edge of the clock signal to a transition edge of the input signal required to produce a valid output signal of the logic circuit 12. For example, such timing value includes a setup time for a high-to-low transition (falling edge) of the input signal (setupHL), a setup time for a low-to-high transition (rising edge) of the input signal (setupLH), a hold time for a high-to-low transition (holdHL), and a hold time for a low-to-high transition (holdLH).

More specifically, the setupHL is the time required for the input signal (D) switching from High to Low prior to an active or triggering edge (typically a rising edge) of the clock signal (CLOCK) so that a specific criteria of an observing node is satisfied. For example, the specific criteria for the high-to-low transition may be that the minimum voltage of an observing node “xil.outn” is to be equal or greater than a selected voltage level. The setupLH is the time required for the input signal (D) switching from Low to High prior to the triggering/active edge of the clock signal (CLOCK) so that a specific criteria of an observing node (typically the output signal at Q) is satisfied. The specific criteria for the setupLH may be defined as a minimum voltage of the output signal, for example, a specific percentage (e.g., 80%) of the supply voltage Vdd so as to ensure the output signal with a logic level High.

Similarly, the holdHL is the time required for the input signal (D) to hold High after the triggering/active edge of the clock signal (CLOCK) so that a specific criteria of the output signal (Q) is satisfied. For example, the specific criteria for the H-to-L hold time may require the maximum voltage of the observing node to be less than 20% of the supply voltage Vdd. The holdLH is the time required for the input signal (D) to hold Low after the triggering/active edge of the clock signal (CLOCK) so that a specific criteria of the output signal (Q) is satisfied. For example, such criteria may require the minimum voltage of the observing node to be greater than a selected voltage level ensuring a logic level High.

The measurement of the signal voltage level at the observing node may be conducted using a measuring window with a selected width (for example, 600 pico-second). The result of the measurement (observation) is either one of satisfying the criteria (successful or “passed”) or failing the criteria (unsuccessful or “failed”). By moving a rising or falling edge of the input signal with respect to the clock signal's triggering/active edge, the corresponding timing value is obtained form measurement of the last successful simulation and the last unsuccessful simulation.

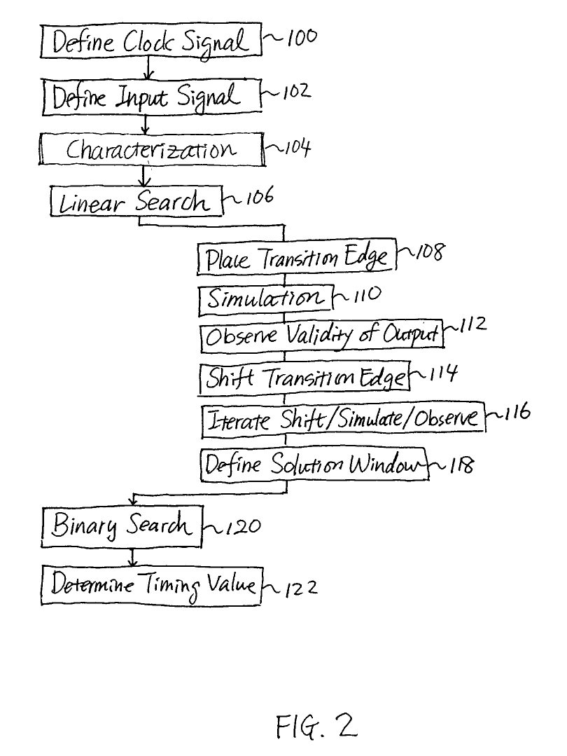

FIG. 2 schematically illustrates a method for characterizing a timing-sensitive digital logic circuit in accordance with one embodiment of the present invention. The clock signal is defined with a set of clock signal parameters (100), and the input signal is defined with a set of input signal parameters (102) before characterizing a timing value of the circuit (104). The clock signal parameters include a timing of an active edge and a clock cycle, and the input signal parameters include a timing of a transition edge.

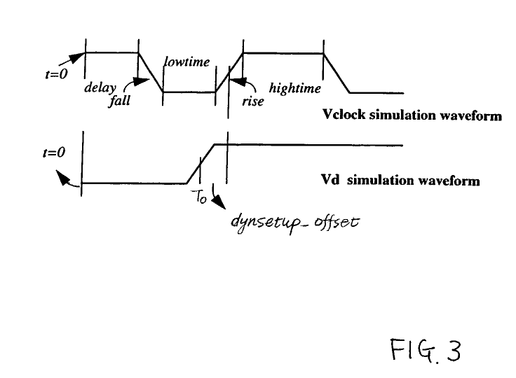

FIG. 3 schematically illustrates the simulation waveforms of the clock signal and the input signal. As shown in FIG. 3, the clock signal Vclock may be defined using global parameters such as delay, rise, fall, lowtime, hightime, which can be set by the user, or by default values. The period (cycle) of the clock signal Vclock is defined as: period=(rise+fall+lowtime+hightime). The waveform of the input signal Vd may be as a simple rising (Low to High) edge or falling (High to Low) edge based on which characterization task is being performed. For example, a rising edge is set for setupLH and holdLH, and a falling edge is set for setupHL and holdHL. Both the input signal waveform Vd and the clock signal waveform Vclock may use rise and fall times defined by global variables rise and fall. A parameter dynsetup_offset may also be added to the input signal parameters so as to specify the initial position (offset) of the rising/falling edge of the input signal with respect to the active edge of the clock signal Vclock. It should be noted that, as shown in FIG. 1, the input pin D and the clock pin CLOCK are connected to outputs of the input buffer 14 and the clock buffer 16, respectively. Thus, the rise and fall times of the input signal (D) and the clock signal (CLOCK) are the rise and fall times of the outputs of the corresponding buffers.

Referring back to FIG. 2, the characterization of a timing value (104) involves a linear search (“sliding window”) (106) to determine a “solution window” for the timing value, and a binary search (120) in the solution window to determine the timing value within a predetermined resolution.

In the linear search (106), the characterization tool starts simulation operation by reading a characterization command. The input signal parameters are set such that the transition edge of the input signal is placed a selected time interval from the active edge of the clock signal (108). After the simulation of the circuit is conducted (110), the output signal is observed (at the observing node) and validity of the output signal is determined (112). For example, determining the validity includes checking the observed result against the criteria for the observing node (such as sdffsetup_node_lh). Depending on the timing value under characterization (for example, setup time or hold time) and the result of the observation (success or failure), the transition edge of the input signal is shifted closer to or away from the active edge of the clock signal by a certain amount (114). That is, the transition edge is shifted by a window having a given time width. Shifting the transition edge can be done by changing the corresponding input signal parameters.

Shifting the transition edge and simulating the circuit are iterated until the validity of the output signal changes, i.e., the measured validity is different from that of the previous simulation (116). When iterating the shift-and-simulate, the time width of the window (window size) is doubled for each iteration operation unless the doubled time width exceeds half the clock cycle. This half the clock cycle limitation is in order not to miss the active edge of the clock signal. The solution window is then defined between the transition edge yielding the last valid output signal (satisfying the criteria) and the transition edge yielding the last invalid output signal (failing the criteria) (118). By doubling the time width for each iteration process, the number of simulations necessary for positioning the solution window is reduced, compared with using the same window size throughout the linear search.

After the solution window is defined, a binary search is conducted within the solution window (120), and the timing value is determined with a predetermined resolution (122).

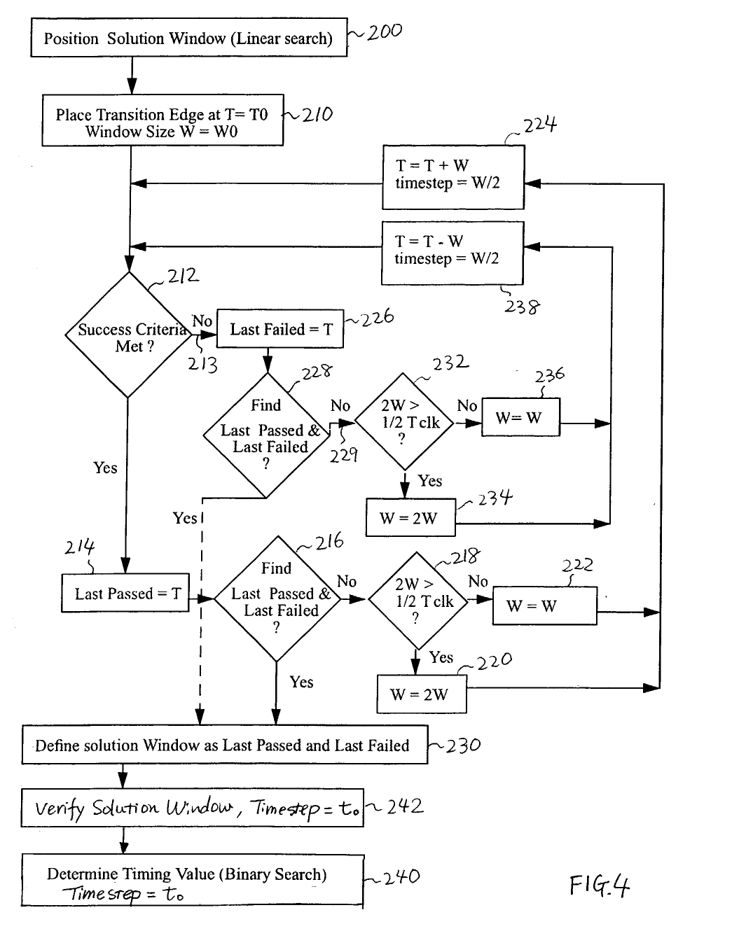

FIG. 4 schematically illustrates a process flow of a method for characterizing a timing-sensitive digital logic circuit in accordance with one embodiment of the present invention. In this example, a setup time for a low-to-high transition edge (rising edge) of the input signal (data signal) is described in detail.

The clock signal waveform is pre-defined as described above, and does not change throughout characterization simulations. The input signal waveform is also defined as described above, but the input signal waveform changed for every characterization simulation. In positioning the solution window (linear search) (200), the initial time difference (offset) between the transition edge of the input signal and the active/triggering edge of the clock signal is set so that the transition edge of the input signal is placed at T=T₀ (202). FIG. 3 also shows the value of parameter dynsetup_offset which may be set in accordance with to a user selection. If the value of the offset parameter is positive, the transition edge is “earlier” than the active edge of the clock signal by this amount. If the value is negative, the transition edge is “later” than the active edge of the clock signal. The time width for shifting the transition edge (sliding window size W) is also set as W=W₀, typically in accordance with a user selection. That is, the linear search starts with a given window size W₀. It should be noted that the position of an edge is measured at the middle of the transition (50% of the maximum transition amount).

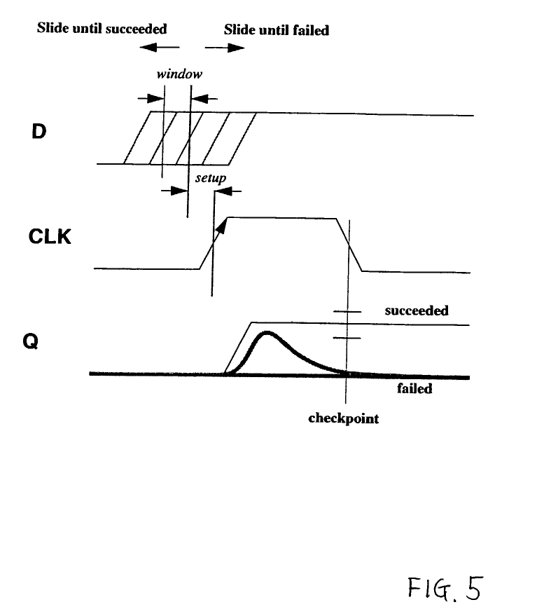

If the value of the offset parameter is large enough (i.e., with a sufficient setup time in this example), the circuit should operate correctly and produce an expected output signal. That is, if the circuit is a flip-flop, its output flips. After simulation, the output signal is measured against the success criteria so as to determine the validity of the output signal (212). The validity may be determined based on whether the output signal is within a specific range of voltage level, as describe above. FIG. 5 schematically illustrates the waveforms of the input signal (D), the clock signal (CLK), and the output signal (Q) in the linear search. As shown in FIG. 5, the output signal may be measured at a selected checkpoint such as a falling edge of the clock signal.

If the output signal is valid and meets the success criteria, the current position (T) of the transition edge is set as “Last Passed” edge (214). Since this is the first simulation, there is no “Last Failed” edge in this point (216). In order to determine a shifting amount, the doubled window size 2W is checked with half the clock cycle Tclk (218). If the doubled window size does not exceed half the clock cycle, the window size is doubled (220). Otherwise, the same window size is maintained (222). Then, the transition edge is shifted by the current window size (224). In case of the setup time, the transition edge is moved rightward (in FIG. 5). Then, circuit simulation is performed again, and process is returned to block 212 for iteration.

When the transition edge of the input signal is moved too close to the active edge of the clock signal, a measured result would not meet the success criteria, for example, the output signal does not have an expected voltage level at the checkpoint as shown in FIG. 5. Then, the current position (T) of the transition edge is set as “Last Failed” (226). If both “Last Failed” and “Last Passed” values are obtained (228), the solution window is defined between the two transition edge positions (230).

In the case where the initial position of the transition edge (T₀) is “later” than or too close to the active edge of the clock signal at block 210, the result of the first simulation would be unsuccessful (213) and the “Last Failed” transition edge position is obtained first (226). In this case, the “Last Passed” edge position is not found (229). The shifting amount is determined by checking if the doubled window size does not exceed half the clock signal cycle (232), and the window size is doubled (234) or is maintained the current value (236) accordingly. Then, the transition edge is shifted by the window size leftward (238) (in FIG. 5), and another circuit simulation is performed so as to return to block 212 for iteration. The iteration is continued until both the “Last Failed” and “Last Passed” transition edge positions are found. Once the solution window is defined (230), the characterization process moves to the binary search (240).

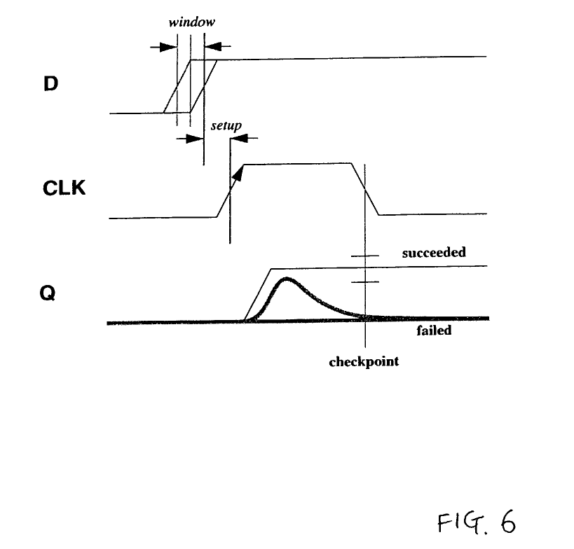

FIG. 6 schematically illustrates the waveforms of the input signal (D), the clock signal (CLK), and the output signal (Q) in the binary search. In the binary search, the solution window is divided in half, and one of the halves containing a successful transition edge is defined as a new window. For example, the output signal is observed for the transition edge placed at the dividing point (at the middle of the solution window) and is checked against the criteria. The new window is assigned to the left half if the output signal failed, or the right half if the output signal is successful. This process is repeated until the window size meets the resolution requirements, for example, until the window is smaller than the resolution parameter. In this way, the timing value (the setup time for a rising edge in this example) is determined within the predetermined resolution (time width). The maximum number of iteration may be set in order to avoid an infinite loop of the binary search if the resolution parameter is set too small.

In accordance with one embodiment of the present invention, the simulation in the linear search is performed using a timestep of half the time width of the last window size. The linear search simulation is conventionally performed using a given timestep typically set by a user as a global parameter. However, in this embodiment, the simulation time step can be changed independent of the user-set timestep during the linear search, such that the timestep set half the sliding window size (224, 238), as shown in FIG. 4. Since the window size W is doubled up to half the clock cycle for each iteration, the simulation time step is also increased for each iteration. This realizes fast coarse level simulations. Before conducting binary search (240), which is performed with the user-given or original time step, the solution window defined at 230 may be verified using the given timestep (242).

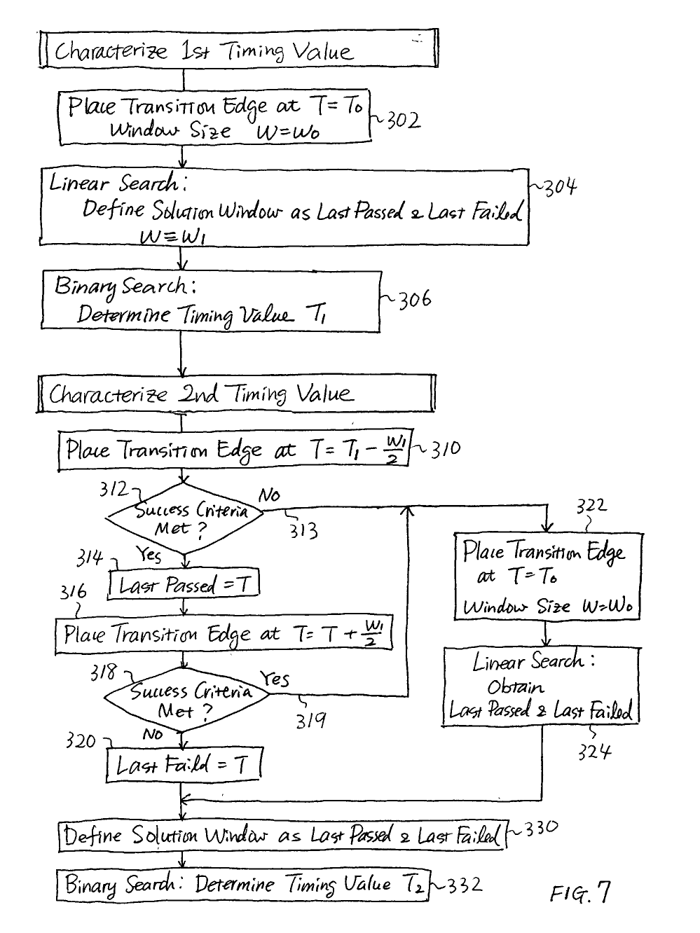

FIG. 7 schematically illustrates a method for characterizing a timing-sensitive digital logic circuit in accordance with one embodiment of the present invention. The clock signal and the input signal are defined with respective set of parameters in the same manner as described above. Also, a first timing value of the circuit is characterized as described in the previous embodiments. Here, the first timing value is a time period from the active edge of the clock signal to a first type of transition edge of the input signal required to produce a valid output signal. For example, the first timing value is the setup time for a Low-to-High edge of the input signal. As shown in FIG. 7, a solution window for the first transition edge is defined by first placing the transition edge a selected time interval from the active edge of the clock signal, i.e., T=T₀ (302), and performing a linear search (304), as described above referring to FIG. 4. The solution window defined for the first transition edge has the size W₁, i.e., the solution window size for the linear search is set as W=W₁ (304). By conducting a binary search within the solution window, the first timing value is determined and set as T=T₁ (306). It should be noted that the solution window size W₁ may be greater than the initial window size W₀ if the window size is doubled one or more times during the linear search 304.

Characterization of a second timing value (especially defining the solution window for the second timing value) is performed using the first timing value T₁ and the solution window size W₁ defined for the first timing value. Here, the second timing value is a time period from the active edge of the clock signal to a second type of transition edge of the input signal required to produce a valid output signal (for example, the setup time for a High-to-Low edge, if the first timing value is the setup time for a Low-to-High edge). Typically, the first and second timing values are of the same operation type (e.g., setup/hold time) for different transition edges (e.g., rising and falling edges).

In determining the solution window for the second timing value, as shown in FIG. 7, the second transition edge is placed at a first time position the first timing value (T₁) less half a width of the solution window (W₁/2) from the active edge of the clock signal, i.e., the second transition edge is positioned at

$$T = {T}_{1} - \frac{{W}_{1}}{2}$$

(310). Simulation of the circuit is performed, and the validity of the output signal is determined by observing if the output signal meets the success criteria (312). If the output signal satisfy the criteria, the edge position is set as “Last Passed” (314).

The transition edge is also placed for simulation at a second time position the first timing value (T₁) plus half a width of the solution window (W₁/2) from the active edge of the clock signal, i.e., the second transition edge is positioned at

$$T = {T}_{1} + \frac{{W}_{1}}{2}$$

(316). The output signal is observed and determined to be valid if it satisfies the success criteria (318). If the output signal does not meet the criteria, the edge position is set as “Last Failed” (320).

If both “Last Passed” and “Last Failed” transition edge positions are obtained, the solution window for the second timing value is defined between the first time position (“Last Passed”) and the second time position (“Last Failed”) (330). Once the solution window for the second timing value is obtained, a binary search is conducted (332) so as to determine the second timing value with a predetermined resolution, as described in the previous embodiments.

Either in the case where the result of the simulation with the second transition edge placed at the first position

$$T = {T}_{1} - \frac{{W}_{1}}{2}$$

dose not satisfy the success criteria (313), or where the result of the simulation with the second transition edge placed at the second position

$$T = {T}_{1} + \frac{{W}_{1}}{2}$$

dose not satisfy the success criteria (319), a renewed characterization process is conducted for the second timing value (322, 324). That is, the second transition edge is first placed at a given setoff position (T=T₀) and “Last passed” and “Last Failed” transition edge positions are obtained by a linear search starting with a given window width W₀.

It should be noted that the order of placing the second transition edge at the first and second positions and the validity order of the output signal are not limited to that described above. The transition edge may be placed at the second position first, and then placed at the first position. Furthermore, FIG. 7 only illustrates the embodiment using an example where the timing value is the setup time of the circuit. Because of the nature of the setup time, the first position

$$T = {T}_{1} - \frac{{W}_{1}}{2}$$

is farther from the active edge of the clock signal, and thus is expected to yield a successful output. The second position

$$T = {T}_{1} + \frac{{W}_{1}}{2} ,$$

which is closer to the active edge, is expected to yield an unsuccessful output. The process flows 313 and 315 are based on these facts. However, when the timing value is the hold time of the circuit, the first position

$$T = {T}_{1} - \frac{{W}_{1}}{2}$$

is closer to the active edge of the clock signal and thus expected to yield an unsuccessful output. Also, the second position

$$T = {T}_{1} + \frac{{W}_{1}}{2} ,$$

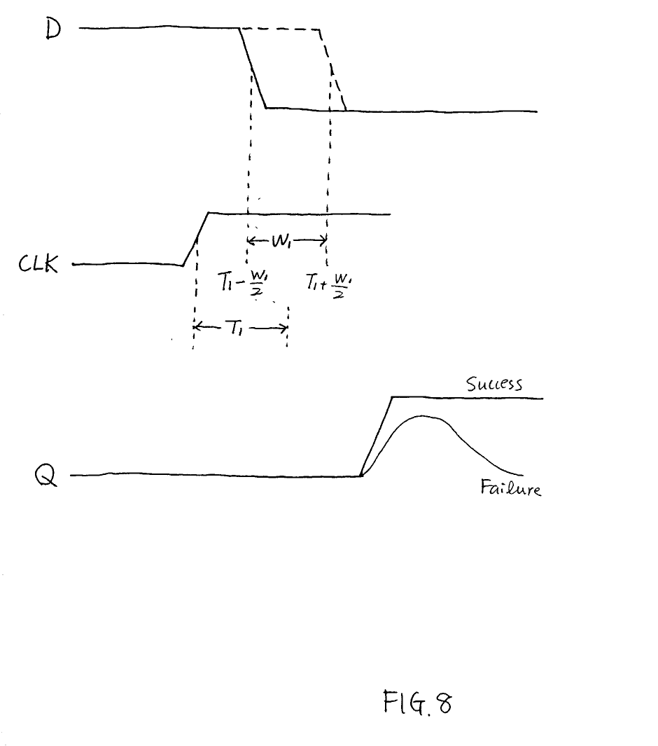

which is farther from the active edge, is expected to yield a successful output. Thus, “Last Failed” would be found at the first position, and “Last Passed” at the second position. FIG. 8 schematically illustrates such a case where the solution window for the second timing value (the hold time for a High-to-Low edge) is being positioned using the first timing value T₁ (the hold time for a Low-to-High edge) and the time width W₁ of the solution window for the first timing value.

In either case, if the validity of the output signal in the second simulation (318) is different from the validity of the output signal in the first simulation (312), the “Last Passed” and “Last Failed” transition edge positions are obtained whichever first, and thus the solution window is defined by these edge positions. If the first and second simulation results are the same, i.e., the “first guess” for the solution window is unsuccessful, the characterization process of the second timing value is restarted with user-given parameters in the same manner as the characterization process for the first timing value.

In the linear search for a solution window for the second timing value (324), the window size (time width for shifting the transition edge) may be doubled for each iterative simulation in the same manner as the previous embodiments. Furthermore, the timestep of the simulation may be half the window size during the linear search of the solution window for the second timing value (324), as well as that for the first timing value (304).

The first timing value and the second timing value are not limited to that correspond to different transition edges, but they may also correspond to the same signal path or “arc” with different slew ratios. In accordance with one embodiment of the present invention, the first timing value is a timing value for a given signal path and a given signal transition of the input signal, and the second timing value is a timing value for the same signal path and the same signal transition with a different slew (i.e., a different load condition). For example, the first timing value is a setup time of a rising edge of an input signal with respect to the clock signal, i.e., the signal path from the input pin D to the output pin Q, with a selected slew which can be specified by the input buffer parameters (see FIG. 1), and the second timing value is a setup time for the same rising edge of the input signal but with a different slew.

Accordingly, if one timing value and its solution window for the linear search are determined for a first type of transition edge with a first slew, the obtained numbers (timing value and window width) can be used for the subsequent characterization processes for a series of combinations of the transition edge type and a slew ratio. The first obtained numbers are used to “guess” the solution window for the next timing value so that the solution window can be found quicker by reducing the number of simulation. If the guess is unsuccessful, the linear search starts from the beginning with user-defined parameters, ensuring obtaining the solution window properly.

This heuristic approach reduces the time of the linear search before conducting the binary search. In addition, doubling the window size and/or the use of a variable simulation timestep in accordance with the window size can be employed separately or combined with each other and with the above heuristics. In addition, since the original/user-defined simulation timestep is restored for the binary search, the user will obtain a simulation/characterization report as specified. Conventional characterization process for latches and flip-flops in a certain case takes more than 18 hours per cell. The embodiments of the present invention described above speed up the characterization process 2 to 2.5 times in most of the cases. However, these numbers are by way of example and are not intended to be exhaustive or limiting in any way.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method for characterizing a timing-sensitive digital logic circuit, the circuit receiving an input signal and producing an output signal in accordance with a clock signal, said method comprising:
defining a clock signal with a set of clock signal parameters, the clock signal parameters including a timing of an active edge and a clock cycle;
defining an input signal with a set of input signal parameters, the input signal parameters including a timing of transition edges; and
characterizing a timing value of the circuit, the timing value being a time period from the active edge of the clock signal to a transition edge of the input signal required to produce a valid output signal, said characterizing including:
setting a set of input signal parameters such that the transition edge is placed a selected time interval from the active edge of the clock signal;
conducting simulation of the circuit;
observing the output signal and determining validity of the output signal;
shifting, by changing the input signal parameters, the transition edge by a window having a given time width;
simulating the circuit so as to observe and determine the validity of the output signal;
iterating said shifting and said simulating by doubling the time width of the window for each iteration unless the doubled time width exceeds half the clock cycle and until the validity of the output signal changes; and
defining a solution window between the transition edge yielding the last valid output signal and the transition edge yielding the last invalid output signal.

2. The method in accordance with claim 1 wherein said characterizing further includes:
determining the timing value with a predetermined resolution within the solution window.

3. The method in accordance with claim 2 wherein said determining includes:
binary-searching the timing value within the solution window.

4. The method in accordance with claim 1 wherein said simulating is performed using a given timestep.

5. The method in accordance with claim 1 wherein said simulating is performed using a timestep of half the time width of the last window size.

6. The method in accordance with claim 5 wherein said characterizing further comprises:
verifying the defined solution window using a given timestep.

7. The method in accordance with claim 6 wherein said characterizing further includes:
determining the timing value with a predetermined resolution within the solution window using the given timestep.

8. The method in accordance with claim 1 wherein the circuit includes a flip-flop.

9. The method in accordance with claim 1 wherein the circuit includes a latch.

10. The method in accordance with claim 1 wherein the timing value is a setup time for a low-to-high transition of the input signal.

11. The method in accordance with claim 1 wherein the timing value is a setup time for a high-to-low transition of the input signal.

12. The method in accordance with claim 1 wherein the timing value is a hold time for a low-to-high transition of the input signal.

13. The method in accordance with claim 1 wherein the timing value is a hold time for a high-to-low transition of the input signal.

14. A method for characterizing a timing-sensitive digital logic circuit, the circuit receiving an input signal and producing an output signal in accordance with a clock signal, said method comprising:
defining the clock signal with a set of clock signal parameters, the clock signal parameters including a timing of an active edge and a clock cycle;
defining the input signal with a set of input signal parameters, the input signal parameters including a timing of transition edges;
characterizing a first timing value of the circuit, the first timing value being a time period from the active edge of the clock signal to a first type of transition edge (first transition edge) of the input signal required to produce a valid output signal, said characterizing including:
setting a set of input signal parameters such that the first transition edge is placed a selected time interval from the active edge of the clock signal;
conducting simulation of the circuit;
observing the output signal and determining validity of the output signal;
shifting, by changing the input signal parameters, the first transition edge by a window having a given time width;
simulating the circuit so as to observe and determine the validity of the output signal;
iterating said shifting and said simulating until the validity of the output signal changes; and
defining a solution window between the first transition edge yielding the last valid output signal and the first transition edge yielding the last invalid output signal.
determining the first timing value with a predetermined resolution within the solution window; and
characterizing a second timing value using the first timing value and the defined solution window, the second timing value being a time period from the active edge of the clock signal to a second type of transition edge (second transition edge) of the input signal required to produce a valid output signal.

15. The method in accordance with claim 14 wherein said iterating said shifting includes doubling the time width of the window for each iteration unless the doubled time width exceeds half the clock cycle.

16. A method in accordance with claim 14 wherein said characterizing the second timing value includes:
placing, by changing the input signal parameters, the second transition edge at a first time position the first timing value less half a width of the solution window from the active edge of the clock signal;
simulating the circuit and first determining validity of the output signal;
placing, by changing the input signal parameters, the second transition edge at a second time position the first timing value plus half the width of the solution window from the active edge of the clock signal;
simulating the circuit and second determining validity of the output signal;
defining a solution window for the second timing value between the first time position and the second time position, if the validity of the output signal in said second determining is different from the validity of the output signal in said first determining; and
determining the second timing value with a predetermined resolution within the solution window for the second timing value.

17. A method according to claim 16 wherein said defining the solution window for the second timing value includes, if the validity of the output signal in said second determining is the same as the validity of the output signal in said first determining:
setting a set of input signal parameters such that the second transition edge of the input signal is placed a selected time interval from the active edge of the clock signal;
conducting simulation of the circuit;
observing the output signal and determining validity of the output signal;
shifting, by changing the input signal parameters, the second transition edge by a window having a given time width;
simulating the circuit and determining the validity of the output signal;
iterating said shifting and said simulating until the validity of the output signal changes; and
defining the solution window for the second timing value between the second transition edge yielding the last valid output signal and the second transition edge yielding the last invalid output signal.

18. The method in accordance with claim 17 wherein said iterating said shifting includes doubling the time width of the window for each iteration unless the doubled time width exceeds half the clock cycle.

19. The method in accordance with claim 16 wherein said determining the second timing value includes:
binary-searching the second timing value within the solution window for the second timing value.

20. The method in accordance with claim 14 wherein the circuit includes a flip-flop.

21. The method in accordance with claim 14 wherein the circuit includes a latch.

22. The method in accordance with claim 14 wherein the first timing value is a setup time for a low-to-high transition edge and the second timing value is a setup time for a high-to-low transition edge.

23. The method in accordance with claim 14 wherein the first timing value is a setup time for a high-to-low transition edge, and the second timing value is a setup time for a low-to-high transition edge.

24. The method in accordance with claim 14 wherein the first timing value is a hold time for a low-to-high transition edge, and the second timing value is a hold time for a high-to-low transition edge.

25. The method in accordance with claim 14 wherein the first timing value is a hold time for a high-to-low transition edge, and the second timing value is a hold time for a low-to-high transition edge.

26. The method in accordance with claim 14 wherein the input signal parameters further include a slew of the input signal.

27. The method in accordance with claim 26 wherein the first timing value is a setup time for a low-to-high transition edge with a first slew, and the second timing value is a setup time for a low-to-high transition edge with a second slew different from the first slew.

28. The method in accordance with claim 26 wherein the first timing value is a setup time for a high-to-low transition edge with a first slew, and the second timing value is a setup time for a high-to-low transition edge with a second slew different from the first slew.

29. The method in accordance with claim 26 wherein the first timing value is a hold time for a low-to-high transition edge with a first slew, and the second timing value is a hold time for a low-to-high transition edge with a second slew different from the first slew.

30. The method in accordance with claim 26 wherein the first timing value is a hold time for a high-to-low transition edge with a first slew, and the second timing value is a hold time for a high-to-low transition edge with a second slew different from the first slew.

31. An apparatus for characterizing a timing-sensitive digital logic circuit, the circuit receiving an input signal and producing an output signal in accordance with a clock signal, said apparatus comprising:
means for defining a clock signal with a set of clock signal parameters, the clock signal parameters including a timing of an active edge and a clock cycle;
means for defining an input signal with a set of input signal parameters, the input signal parameters including a timing of transition edges; and
means for characterizing a timing value of the circuit, the timing value being a time period from the active edge of the clock signal to a transition edge of the input signal required to produce a valid output signal, said means for characterizing including:
means for setting a set of input signal parameters such that the transition edge is placed a selected time interval from the active edge of the clock signal;
means for conducting simulation of the circuit;
means for observing the output signal and determining validity of the output signal;
means for shifting the transition edge by a window having a given time width;
means for simulating the circuit so as to observe and determine the validity of the output signal;
means for iteratively executing said means for shifting and said means for simulating by doubling the time width of the window for each iteration unless the doubled time width exceeds half the clock cycle and until the validity of the output signal changes; and
means for defining a solution window between the transition edge yielding the last valid output signal and the transition edge yielding the last invalid output signal.

32. The apparatus in accordance with claim 31 wherein said means for characterizing further includes:
means for determining the timing value with a predetermined resolution within the solution window.

33. The apparatus in accordance with claim 32 wherein said means for determining includes:
means for binary-searching the timing value within the solution window.

34. The apparatus in accordance with claim 31 wherein said means for simulating is performed using a given timestep.

35. The apparatus in accordance with claim 31 wherein said means for simulating is performed using a timestep of half the time width of the last window size.

36. The apparatus in accordance with claim 35 wherein said means for characterizing further comprises:
means for verifying the defined solution window using a given timestep.

37. The apparatus in accordance with claim 36 wherein said means for characterizing further includes:
means for determining the timing value with a predetermined resolution within the solution window using the given timestep.

38. The apparatus in accordance with claim 31 wherein the circuit includes a flip-flop.

39. The apparatus in accordance with claim 31 wherein the circuit includes a latch.

40. The apparatus in accordance with claim 31 wherein the timing value is a setup time for a low-to-high transition of the input signal.

41. The apparatus in accordance with claim 31 wherein the timing value is a setup time for a high-to-low transition of the input signal.

42. The apparatus in accordance with claim 31 wherein the timing value is a hold time for a low-to-high transition of the input signal.

43. The apparatus in accordance with claim 31 wherein the timing value is a hold time for a high-to-low transition of the input signal.

44. An apparatus for characterizing a timing-sensitive digital logic circuit, the circuit receiving an input signal and producing an output signal in accordance with a clock signal, said apparatus comprising:
means for defining the clock signal with a set of clock signal parameters, the clock signal parameters including a timing of an active edge and a clock cycle;
means for defining the input signal with a set of input signal parameters, the input signal parameters including a timing of transition edges;
means for characterizing a first timing value of the circuit, the first timing value being a time period from the active edge of the clock signal to a first type of transition edge (first transition edge) of the input signal required to produce a valid output signal, said means for characterizing including:
means for setting a set of input signal parameters such that the first transition edge is placed a selected time interval from the active edge of the clock signal;
means for conducting simulation of the circuit;
means for observing the output signal and determining validity of the output signal;
means for shifting, by changing the input signal parameters, the first transition edge by a window having a given time width;
means for simulating the circuit so as to observe and determine the validity of the output signal;
means for iteratively executing said means for shifting and said means for simulating until the validity of the output signal changes; and
means for defining a solution window between the first transition edge yielding the last valid output signal and the first transition edge yielding the last invalid output signal.
means for determining the first timing value with a predetermined resolution within the solution window; and
means for characterizing a second timing value using the first timing value and the defined solution window, the second timing value being a time period from the active edge of the clock signal to a second type of transition edge (second transition edge) of the input signal required to produce a valid output signal.

45. The apparatus in accordance with claim 44 wherein said means for iteratively executing said means for shifting includes doubling the time width of the window for each iteration unless the doubled time width exceeds half the clock cycle.

46. An apparatus in accordance with claim 44 wherein said means for characterizing the second timing value includes:
means for placing the second transition edge at a first time position the first timing value less half a width of the solution window from the active edge of the clock signal;
means for simulating the circuit so as to determine first validity of the output signal;
means for placing the second transition edge at a second time position the first timing value plus half the width of the solution window from the active edge of the clock signal;
means for simulating the circuit so as to determine second validity of the output signal;
means for defining a solution window for the second timing value between the first time position and the second time position, if the first validity of the output signal is different from the second validity of the output signal; and
means for determining the second timing value with a predetermined resolution within the solution window for the second timing value.

47. An apparatus according to claim 46 wherein said means for defining the solution window for the second timing value includes, if the second validity of the output signal is the same as the first validity of the output signal:
means for setting a set of input signal parameters such that the second transition edge of the input signal is placed a selected time interval from the active edge of the clock signal;
means for conducting simulation of the circuit;
means for observing the output signal and determining validity of the output signal;
means for shifting the second transition edge by a window having a given time width;
means for simulating the circuit and determining the validity of the output signal;
means for iteratively executing said means for shifting and said means for simulating until the validity of the output signal changes; and
means for defining the solution window for the second timing value between the second transition edge yielding the last valid output signal and the second transition edge yielding the last invalid output signal.

48. The apparatus in accordance with claim 47 wherein said means for iteratively executing said means for shifting includes means for doubling the time width of the window for each iteration unless the doubled time width exceeds half the clock cycle.

49. The apparatus in accordance with claim 46 wherein said means for determining the second timing value includes:
means for binary-searching the second timing value within the solution window for the second timing value.

50. The apparatus in accordance with claim 44 wherein the circuit includes a flip-flop.

51. The apparatus in accordance with claim 44 wherein the circuit includes a latch.

52. The apparatus in accordance with claim 44 wherein the first timing value is a setup time for a low-to-high transition edge and the second timing value is a setup time for a high-to-low transition edge.

53. The apparatus in accordance with claim 44 wherein the first timing value is a setup time for a high-to-low transition edge, and the second timing value is a setup time for a low-to-high transition edge.

54. The apparatus in accordance with claim 44 wherein the first timing value is a hold time for a low-to-high transition edge, and the second timing value is a hold time for a high-to-low transition edge.

55. The apparatus in accordance with claim 44 wherein the first timing value is a hold time for a high-to-low transition edge, and the second timing value is a hold time for a low-to-high transition edge.

56. The apparatus in accordance with claim 44 wherein the input signal parameters further include a slew of the input signal.

57. The apparatus in accordance with claim 56 wherein the first timing value is a setup time for a low-to-high transition edge with a first slew, and the second timing value is a setup time for a low-to-high transition edge with a second slew different from the first slew.

58. The apparatus in accordance with claim 56 wherein the first timing value is a setup time for a high-to-low transition edge with a first slew, and the second timing value is a setup time for a high-to-low transition edge with a second slew different from the first slew.

59. The apparatus in accordance with claim 56 wherein the first timing value is a hold time for a low-to-high transition edge with a first slew, and the second timing value is a hold time for a low-to-high transition edge with a second slew different from the first slew.

60. The apparatus in accordance with claim 56 wherein the first timing value is a hold time for a high-to-low transition edge with a first slew, and the second timing value is a hold time for a high-to-low transition edge with a second slew different from the first slew.

61. A program storage device readable by a machine, tangibly embodying a program of instructions executable by the machine to perform a method for characterizing a timing-sensitive digital logic circuit, the circuit receiving an input signal and producing an output signal in accordance with a clock signal, said method comprising:
defining a clock signal with a set of clock signal parameters, the clock signal parameters including a timing of an active edge and a clock cycle;
defining an input signal with a set of input signal parameters, the input signal parameters including a timing of transition edges; and
characterizing a timing value of the circuit, the timing value being a time period from the active edge of the clock signal to a transition edge of the input signal required to produce a valid output signal, said characterizing including:
setting a set of input signal parameters such that the transition edge is placed a selected time interval from the active edge of the clock signal;
conducting simulation of the circuit;
observing the output signal and determining validity of the output signal;
shifting, by changing the input signal parameters, the transition edge by a window having a given time width;
simulating the circuit so as to observe and determine the validity of the output signal;
iterating said shifting and said simulating by doubling the time width of the window for each iteration unless the doubled time width exceeds half the clock cycle and until the validity of the output signal changes; and
defining a solution window between the transition edge yielding the last valid output signal and the transition edge yielding the last invalid output signal.

62. The program storage device in accordance with claim 61 wherein said characterizing further includes:
determining the timing value with a predetermined resolution within the solution window.

63. A program storage device readable by a machine, tangibly embodying a program of instructions executable by the machine to perform a method for characterizing a timing-sensitive digital logic circuit, the circuit receiving an input signal and producing an output signal in accordance with a clock signal, said method comprising:
defining the clock signal with a set of clock signal parameters, the clock signal parameters including a timing of an active edge and a clock cycle;
defining the input signal with a set of input signal parameters, the input signal parameters including a timing of transition edges;
characterizing a first timing value of the circuit, the first timing value being a time period from the active edge of the clock signal to a first type of transition edge (first transition edge) of the input signal required to produce a valid output signal, said characterizing including:
setting a set of input signal parameters such that the first transition edge is placed a selected time interval from the active edge of the clock signal;
conducting simulation of the circuit;
observing the output signal and determining validity of the output signal;
shifting, by changing the input signal parameters, the first transition edge by a window having a given time width;
simulating the circuit so as to observe and determine the validity of the output signal;
iterating said shifting and said simulating until the validity of the output signal changes; and
defining a solution window between the first transition edge yielding the last valid output signal and the first transition edge yielding the last invalid output signal.
determining the first timing value with a predetermined resolution within the solution window; and
characterizing a second timing value using the first timing value and the defined solution window, the second timing value being a time period from the active edge of the clock signal to a second type of transition edge (second transition edge) of the input signal required to produce a valid output signal.

64. The program storage device in accordance with claim 63 wherein said iterating said shifting includes doubling the time width of the window for each iteration unless the doubled time width exceeds half the clock cycle.

65. The program storage device in accordance with claim 63 wherein said characterizing the second timing value includes:
placing, by changing the input signal parameters, the second transition edge at a first time position the first timing value less half a width of the solution window from the active edge of the clock signal;
simulating the circuit and first determining validity of the output signal;
placing, by changing the input signal parameters, the second transition edge at a second time position the first timing value plus half the width of the solution window from the active edge of the clock signal;
simulating the circuit and second determining validity of the output signal;
defining a solution window for the second timing value between the first time position and the second time position, if the validity of the output signal in said second determining is different from the validity of the output signal in said first determining; and
determining the second timing value with a predetermined resolution within the solution window for the second timing value.

66. A program storage device according to claim 65 wherein said defining the solution window for the second timing value includes, if the validity of the output signal in said second determining is the same as the validity of the output signal in said first determining:
setting a set of input signal parameters such that the second transition edge of the input signal is placed a selected time interval from the active edge of the clock signal;
conducting simulation of the circuit;
observing the output signal and determining validity of the output signal;
shifting, by changing the input signal parameters, the second transition edge by a window having a given time width;
simulating the circuit and determining the validity of the output signal;
iterating said shifting and said simulating until the validity of the output signal changes; and
defining the solution window for the second timing value between the second transition edge yielding the last valid output signal and the second transition edge yielding the last invalid output signal.

67. The program storage device in accordance with claim 66 wherein said iterating said shifting includes doubling the time width of the window for each iteration unless the doubled time width exceeds half the clock cycle.

68. The program storage device in accordance with claim 65 wherein said determining the second timing value includes:
binary-searching the second timing value within the solution window for the second timing value.
